(19) United States
(12) Patent Application Publication
(10) Pub. No.: US 2025/0147895 A1
(43) Pub. Date: May 8, 2025

(54) PROGRAM PROCESSING DEVICE AND PROGRAM PROCESSING METHOD

(71) Applicant: Mitsubishi Electric Corporation, Tokyo (JP)

(72) Inventor: Shoei NASHIMOTO, Tokyo (JP)

(73) Assignee: Mitsubishi Electric Corporation, Tokyo (JP)

(21) Appl. No.: 19/015,883

(22) Filed: Jan. 10, 2025

Related U.S. Application Data
(63) Continuation of application No. PCT/JP2022/034643, filed on Sep. 15, 2022.

(51) Int. Cl. G06F 12/10

(52) U.S. Cl. CPC G06F 12/10; G06F 2212/251

(57) ABSTRACT

A program processing device includes an address mask table generation section, a countermeasure application section, and an execution section. The address mask table generation section generates an address mask table based on setting data. The countermeasure application section attaches a call wrapper to a program, identifies a transition process of performing context switch from the program, and replaces the transition process with a process of performing a jump by specifying a physical address where the call wrapper is to be deployed. The execution section looks up the address mask table in executing a countermeasure-applied program, allocates a memory and assigns a physical address. Instead of acquiring a jump address with no change in the transition process, the execution section makes a change so as to use a jump address obtained by unmasking the jump address acquired by looking up the address mask table, based on determined isolation setting.

### CROSS REFERENCE TO RELATED APPLICATION

This application is a Continuation of PCT International Application No. PCT/JP2022/034643, filed on Sep. 15, 2022, which is hereby expressly incorporated by reference into the present application.

### TECHNICAL FIELD

The present disclosure relates to a program processing device, a program processing method, and a program processing program.

### BACKGROUND ART

TEE is a secure execution environment that controls access between applications by using a memory protection mechanism of a processor. Note that TEE is short for Trusted Execution Environment. For example, when a security-critical application is executed on a TEE, even if vulnerability is found in a library or the application, the impact of the vulnerability can be prevented from propagating to the security-critical application.

TEE is a mechanism to prevent software attacks. Meanwhile, it has been pointed out that a TEE environment of a device, such as an embedded device, that is physically accessible is at risk of a physical attack called fault attack. A fault attack is an attack that actively acts on a processor, causing an instruction skip or data error, to induce a temporary calculation error or data error. Non-Patent Literature 1 shows that a physical attack method called a fault injection attack invalidates access privilege setting of a memory protection mechanism, thereby enabling memory access that is not normally permitted.

### CITATION LIST

### Non-Patent Literature

Non-Patent Literature 1: Nashimoto, Shoei, et al. “Bypassing Isolated Execution on RISC-V using Side-Channel-Assisted Fault-Injection and Its Countermeasure.” IACR Transactions on Cryptographic Hardware and Embedded Systems (2022): 28-68.

### SUMMARY OF INVENTION

### Technical Problem

For example, in order to prevent physical attacks on a TEE, there is a method with which an entry point is masked by a value of a protection target, that is, a setting value of an access privilege. The masked entry point is unmasked at the time of execution, and the original entry point is calculated.

However, with an OS that dynamically loads and maps a protection-target program, isolation setting changes dynamically with each execution, so entry point masking cannot be used. Note that OS is short for Operating System. The OS which dynamically loads and maps a protection-target program is an OS that loads the program to the memory, allocates a physical memory, and assigns a logical address, so that the program can be executed.

The present disclosure has as its objective to prevent unauthorized memory access by calculating transition to a program based on a jump address which is masked with an expected isolation setting value in advance.

### Solution to Problem

A program processing device according to the present disclosure includes:
setting data which specifies a physical address and a logical address about a program or a memory used by the program;
a call wrapper being a function that performs context switch;
an address mask table generation section to generate an address mask table based on the setting data;
a countermeasure application section to attach to the program the call wrapper; to identify a transition process of performing the context switch from the program; and to replace the transition process with a process of performing a jump by specifying a physical address where the call wrapper is to be deployed; and
an execution section to look up the address mask table, in executing a countermeasure-applied program, so as to allocate a memory and to assign a physical address; and instead of acquiring a jump address with no change in the transition process, to make a change so as to use a jump address obtained by unmasking the jump address acquired by looking up the address mask table, based on determined isolation setting.

### Advantageous Effects of Invention

In the present disclosure, even in an OS environment where a protection-target program is dynamically loaded and mapped, isolation setting, an entry point, and a jump address can be fixed by loading and mapping the program by using an address mask table. In the present disclosure, a transition to a program is calculated based on a jump address masked with an expected isolation setting value in advance. Hence, if the isolation setting has an unexpected value due to an attack or the like, the transition will not be executed as intended and the attack will not be successful. Therefore, a program processing device according to the present disclosure has an effect of preventing unauthorized memory access.

### BRIEF DESCRIPTION OF DRAWINGS

FIG. 1 is a diagram illustrating a configuration example of a program processing device according to Embodiment 1.

FIG. 2 is a diagram illustrating a configuration example of an address mask table according to Embodiment 1.

FIG. 3 is a flowchart illustrating operation of a program processing device according to Embodiment 1.

FIG. 4 is a flowchart illustrating operation of an address mask table generation section according to Embodiment 1.

FIG. 5 is a diagram illustrating an example of isolation setting for realizing access control according to Embodiment 1.

FIG. 6 is a flowchart illustrating operation of a countermeasure application section according to Embodiment 1.

FIG. 7 is a flowchart illustrating operation of an execution section according to Embodiment 1.

FIG. 8 is a diagram illustrating a sequence from change of isolation setting to execution of a jump address unmasking process according to Embodiment 1.

FIG. 9 is a diagram illustrating a configuration example of a program processing device 100 according to Embodiment 2.

FIG. 10 is a flowchart illustrating operation of the program processing device 100 according to Embodiment 2.

FIG. 11 is a flowchart illustrating operation of an address mask table generation section according to Embodiment 2.

FIG. 12 is a flowchart illustrating operation of a program countermeasure application section according to Embodiment 2.

FIG. 13 is a flowchart illustrating operation of a security monitor countermeasure application section according to Embodiment 2.

### DESCRIPTION OF EMBODIMENTS

Present embodiments will be described below with reference to drawings. In the drawings, the same or equivalent portions are denoted by the same reference numeral. In description of the embodiments, explanation for the same or equivalent portions will be omitted or simplified as appropriate. Arrows in the drawings mainly indicate data flows or process flows.

### Embodiment 1

### Description of Configuration

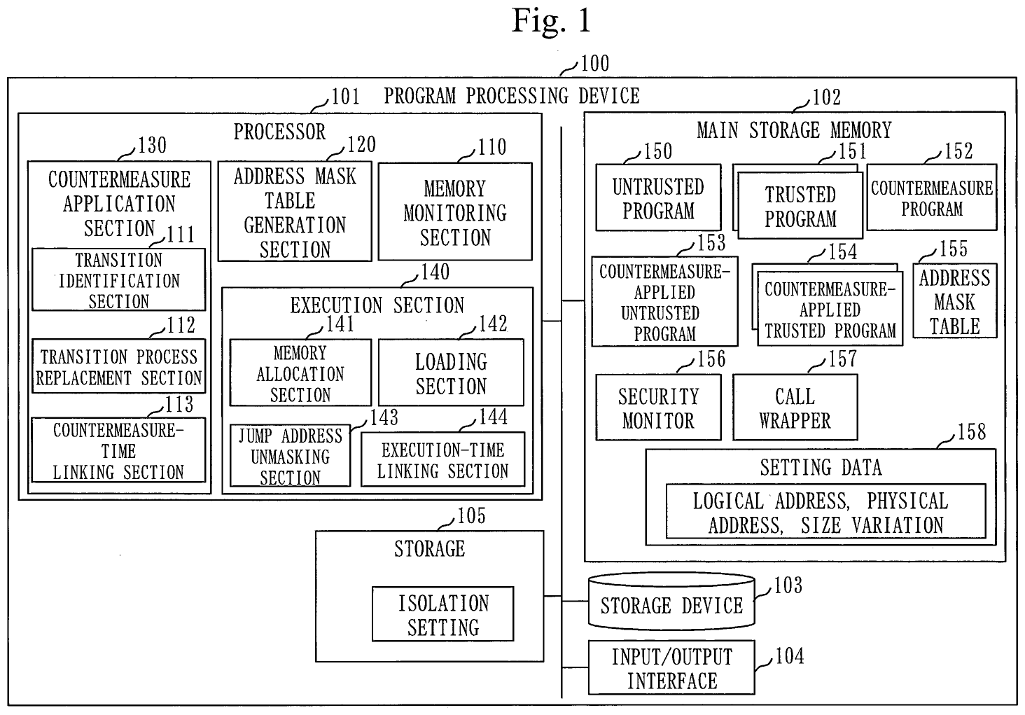

FIG. 1 is a diagram illustrating a configuration example of a program processing device 100 according to the present embodiment.

The program processing device 100 is a computer provided with a processor 101, a main storage memory 102, a storage device 103, an input/output interface 104, and a storage 105. These hardware devices are connected to each other via a signal line.

The processor 101 is an IC to perform computation processing and controls the other hardware devices.

The processor 101 has an arithmetic register, and loads instructions and data to the arithmetic register to execute data processing according to the instructions.

For example, the processor 101 is a CPU or FPGA.

Note that IC is short for Integrated Circuit.

Note that CPU is short for Central Processing Unit.

Note that FPGA is short for Field-Programmable Gate Array.

The processor 101 is also called processing circuitry. That is, features of the program processing device 100 are realized by processing circuitry.

The main storage memory 102 is at least either one or the other of a volatile storage device and a nonvolatile storage device. A specific example of the volatile storage device is a RAM. A specific example of the nonvolatile storage device is a ROM, an HDD, or a flash memory.

Note that RAM is short for Random-Access Memory.

Note that ROM is short for Read Only Memory.

Note that HDD is short for Hard Disk Drive.

Below, an address refers to a memory address of the main storage memory 102.

The storage device 103 is a nonvolatile storage device to keep data. A specific example of the nonvolatile storage device is a ROM, an HDD, or a flash memory.

The input/output interface 104 is an interface for input and output. For example, the input/output interface 104 is a serial communication interface or a debug interface. A specific example of the serial communication interface is an SPI, a UART, or I2C. A specific example of the debug interface is a JTAG or a JWD.

Note that SPI is short for Serial Peripheral Interface.

Note that UART is short for Universal Asynchronous Receiver Transmitter.

Note that I2C is short for Inter-Integrated Circuit.

Note that JTAG is short for Joint Test Action Group.

Note that SWD is short for Serial Wire Debug.

The storage 105 is a storage device.

A specific example of the storage 105 is a memory or a register.

The storage 105 stores data to be accessed by the processor 101.

The storage 105 may constitute part of the main storage memory 102 or part of the storage device 103, may be a register of the processor 101, or may be an independent storage device.

The processor 101 is provided with elements such as a memory monitoring section 110, an address mask table generation section 120, a countermeasure application section 130, and an execution section 140.

The memory monitoring section 110 is implemented by hardware such as a memory monitoring unit incorporated in the processor. For example, the memory monitoring section 110 is a memory management unit which converts a logical address handled by software and a physical address handled by hardware, or a memory protection unit which prevents illegal program access.

The address mask table generation section 120, the countermeasure application section 130, and the execution section 140 are implemented by software.

The word “section” in each term of the memory monitoring section 110, the address mask table generation section 120, the countermeasure application section 130, and the execution section 140 may be replaced with “circuit”, “stage”, “procedure”, “process”, or “circuitry”. A program processing program causes the computer to execute a memory monitoring process, an address mask table generation process, a countermeasure application process, and an execution process. The word “process” in each term of the memory monitoring process, the address mask table generation process, the countermeasure application process, and the execution process may be replaced with “program”, “program product”, “computer readable storage medium which stores a program”, or “computer readable recording medium which is recorded with a program”. A program processing method is a method performed by the program processing device 100 executing the program processing program.

The program processing program may be provided in a state of being stored in a computer readable recording medium. Also, the program processing may be provided in the form of a program product.

The storage device 103 stores:
an Untrusted program 150 operated by the processor 101;
one or a plurality of Trusted programs 151:
a countermeasure program 152 which executes the address mask table generation section 120, the countermeasure application section 130, and the execution section 140;
a countermeasure-applied Untrusted program 153 and a countermeasure-applied Trusted program 154 which are generated by the countermeasure program 152 executing the countermeasure application section 130;
an address mask table 155 generated by the countermeasure program 152 executing the address mask table generation section 120;
a security monitor 156 to change isolation setting of the memory monitoring section 110, the change being necessary for executing the countermeasure-applied Untrusted program 153 and the countermeasure-applied Trusted program 154;
a call wrapper 157 necessary for the countermeasure program 152 to execute the address mask table generation section 120, the countermeasure application section 130, and the execution section 140; and
setting data 158 necessary for the countermeasure program 152 to execute the address mask table generation section 120.

The storage device 103 stores an operating system, a network driver, and a storage driver.

As illustrated in FIG. 1, software and data which are stored in the storage device 103 are loaded to the main storage memory 102.

The Untrusted program 150 is an untrustable program executed on an ordinary OS.

The Trusted program 151 is a trustable program executed on a secure environment (TEE).

The Trusted program 151 is a protection-target program which is to be protected.

The countermeasure-applied Untrusted program 153 and the countermeasure-applied Trusted program 154 are programs to which the countermeasure program 152 has applied an attack countermeasure.

The security monitor 156 is a program that mainly changes isolation setting saved in the storage 105 and performs context switch of the countermeasure-applied Untrusted program 153 and of the countermeasure-applied Trusted program 154.

The security monitor 156 is a program that generally operates with higher privilege than the countermeasure-applied Untrusted program 153, the countermeasure-applied Trusted program 154, and the OS.

The Untrusted program 150, the Trusted program 151, the countermeasure program 152, the countermeasure-applied Untrusted program 153, the countermeasure-applied Trusted program 154, and the security monitor 156 are execution modules with an executable format.

The execution modules are written with binary codes, in a machine language that can be interpreted by the processor 101.

FIG. 1 illustrates a state immediately before the processor 101 loads the countermeasure program 152 to the main storage memory 102 and the processor 101 executes the execution section 140.

The countermeasure program 152 is a program that enhances the security of the trusted program 151. To achieve this, the countermeasure is applied to the Untrusted program 150 as well.

The countermeasure program 152 is a program that implements features of the address mask table generation section 120, countermeasure application section 130, and execution section 140.

The call wrapper 157 is a wrapper (which abstracts and provides a certain process) function which is proxy for context switch attached in order to fix an address of an entry point. To put it simply, the call wrapper 157 executes an environment call exception instruction to call the security monitor 156.

The call wrapper 157 is an execution module with a format of a library or the like.

The storage 105 stores isolation setting. Isolation setting signifies values associated with the countermeasure-applied Untrusted program 153, the countermeasure-applied Trusted program 154, the security monitor 156, and a physical memory which is used by a shared memory shared by these programs. That is, the isolation setting signifies setting values for the memory monitoring section 110 to monitor memory access to these physical addresses, in accordance with a context state. For example, the isolation setting includes a protection-target physical address, an area around the physical address, and an access privilege. The access privilege is a privilege to perform execute, read from, and write on a certain memory.

The setting data 158 signifies a setting value for generating the address mask table 155.

Specifically, the setting data 158 includes, for example:
a logical address to map the call wrapper 157 executed by the countermeasure-applied Untrusted program 153;
a logical address to map the countermeasure-applied Trusted program 154;
a physical address to be used by the shared memory; and
size variations that may be used for the shared memory (for example, 128 MB and 1 GB.

The countermeasure application section 130 includes a transition identification section 111, a transition process replacement section 112, and a countermeasure-time linking section 113. These sections are auxiliary features for implementing the countermeasure application section 130.

The execution section 140 includes a memory allocation section 141, a loading section 142, a jump address unmasking section 143, and an execution-time linking section 144. These sections are auxiliary features for implementing the features of the execution section 140 by extending part of the processing of the security monitor 156 or of the OS.

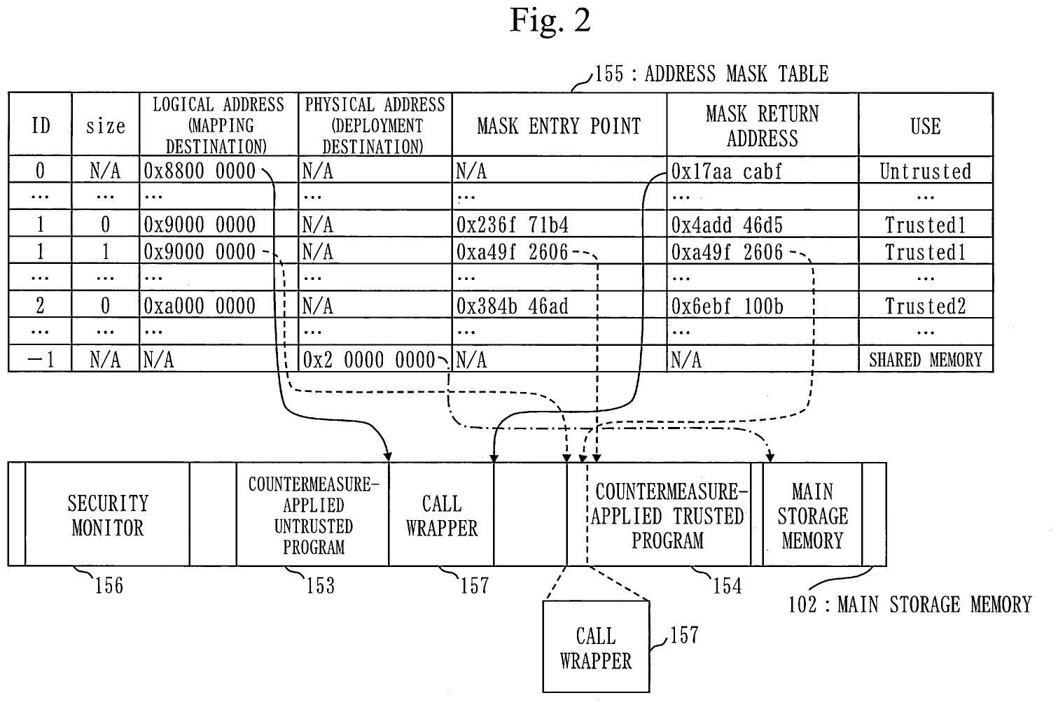

FIG. 2 is a diagram illustrating a configuration example of the address mask table 155 according to the present embodiment.

Before describing the operation, a specific example of how to use the address mask table 155 will be explained with referring to FIG. 2.

FIG. 2 illustrates an address mask table 155, and a state of the main storage memory 102 in execution of the countermeasure-applied Untrusted program 153 and countermeasure-applied Trusted program 154 with using the address mask table 155.

In the address mask table 155, it is possible to refer to a logical address, a physical address, a mask entry point, a mask return address, and use, by specifying a number (ID) and a size (size). Each piece of information such as the logical address, the physical address, the mask entry point, the mask return address, and the use is also called “content”. The logical address is used as a logical address for mapping the call wrapper 157 called by the countermeasure-applied Untrusted program 153, or as a logical address for mapping the countermeasure-applied Trusted program 154. The physical address indicates a base physical address (a leading address of the physical memory to be used) used by the shared memory.

The security monitor 156 has been deployed in the main storage memory 102.

Since the countermeasure-applied Untrusted program 153 is loaded and mapped in execution, a physical address and a logical address are automatically assigned to the countermeasure-applied Untrusted program 153. Assignment for the call wrapper 157 is performed by reference to the logical address from a row with ID=0 of the address mask table 155. The physical address may be assigned to an automatically allocated area. Also, a value that is an unmasked value of a mask return address on the same row expresses a return instruction to return to a caller routine of the call wrapper 157.

The countermeasure-applied Trusted program 154 is loaded and mapped by reference to the address mask table 155 during operation of the countermeasure-applied Untrusted program 153. As with the countermeasure-applied Untrusted program 153, the physical address to be used is assigned to an automatically allocated area, and the logical address to map is assigned by reference to the row with ID=1 in the address mask table 155. A value that is an unmasked value of a mask entry point of the same row expresses an entry point located beyond the call wrapper 157 attached to the beginning of the countermeasure-applied Trusted program 154. Similarly, a value that is an unmasked value of a mask return address expresses a return instruction to return to a caller routine of this call wrapper 157.

The area of the shared memory is allocated by specifying a physical address. The logical address to map may be a logical address that is allocated automatically. It is assumed that the shared memory has a size variation according to the operation of the countermeasure-applied Untrusted program 153. Therefore, the mask jump address of the countermeasure-applied Trusted program 154 has a plurality of variations.

### Description of Operation

Next, operation of the program processing device 100 according to the present embodiment will be described. An operation procedure of the program processing device 100 corresponds to a program processing method. A program that implements the operation of the program processing device 100 corresponds to a program processing program.

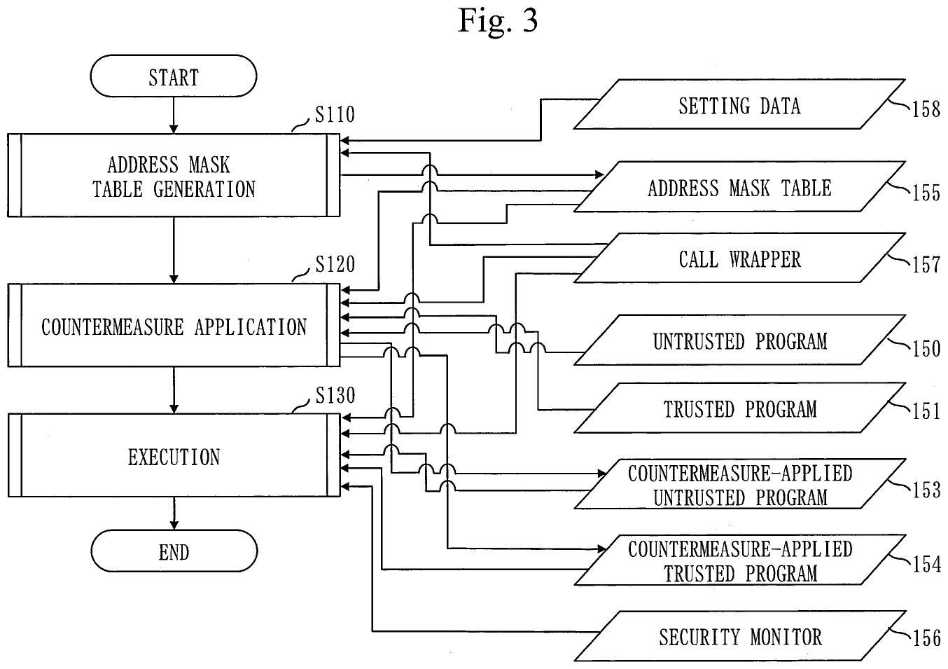

FIG. 3 is a flowchart illustrating the operation of the program processing device 100 according to the present embodiment.

Assume that before operation start, the security monitor 156 has already operated, and values are assigned in the setting data 158.

FIG. 3 expresses operation that takes place when the program processing device 100 executes the countermeasure program 152.

In step S110, the countermeasure program 152 executes a feature of the address mask table generation section 120. The address mask table generation section 120 generates the address mask table 155 about the program or a memory used by the program based on the setting data 158 which specifies a physical address and a logical address. In generation of the address mask table 155, the setting data 158 and the call wrapper 157 are inputted, and the address mask table 155 is outputted.

In step S120, the countermeasure program 152 executes a feature of the countermeasure application section 130. The countermeasure application section 130 attaches to the program the call wrapper 157 being a function that performs context switch, and identifies a transition process of performing the context switch from the program. Then, the countermeasure application section 130 replaces the transition process with a process of performing a jump by specifying a physical address where the call wrapper 157 is to be deployed. In application of the countermeasure, the address mask table 155, the call wrapper 157, the Untrusted program 150, and the Trusted program 151 are inputted, and the countermeasure-applied Untrusted program 153 and the countermeasure-applied Trusted program 154 are outputted.

Specifically, the countermeasure-time linking section 113 attaches the call wrapper 157 to the program. The transition identification section 111 identifies a process of performing the context switch from the program. The transition process replacement section 112 replaces the identified transition process with the process of performing a jump by specifying the address where the call wrapper 157 is to be deployed.

In step S130, the countermeasure program 152 executes a feature of the execution section 140. The execution section 140 looks up the address mask table 155, in executing the countermeasure-applied program, to allocate a memory, and assigns a physical address. Then, instead of acquiring a jump address with no change in the transition process, the execution section 140 makes a change so as to use a jump address obtained by unmasking the jump address acquired by looking up the address mask table 155, based on a determined isolation setting. In executing the program, the address mask table 155, the call wrapper 157, the countermeasure-applied Untrusted program 153, and the countermeasure-applied Trusted program 154 are inputted, and processes of the countermeasure-applied Untrusted program 153 and countermeasure-applied Trusted program 154 are executed. Although the security monitor 156 is explicitly indicated like an input in the flowchart, the security monitor 156 is assumed to have been executed in advance, as has been described earlier.

Specifically, during execution of the countermeasure-applied programs, the memory allocation section 141 and the loading section 142 look up the address mask table 155 to allocate the memory, and assigns a logical address. In the transition process of the context switch, instead of acquiring a jump address with no change, a change is made so as to use the jump address obtained with the jump address unmasking section 143 by unmasking the jump address acquired by looking up the address mask table 155, based on the determined isolation setting.

Normally, the jump address is acquired from a memory located somewhere. On the other hand, in the countermeasure of the present embodiment, the following processes are performed.
1) Look up the address mask table to acquire a masked jump address.
2) Unmask the jump address based on the determined isolation setting (specifically, registers such as pmpcfg and pmpaddr to be described later).

In this manner, a jump address that is the same as that of a normal state is restored. The jump address unmasking section 143 performs these processes.

### <Address Mask Table Generation Process>

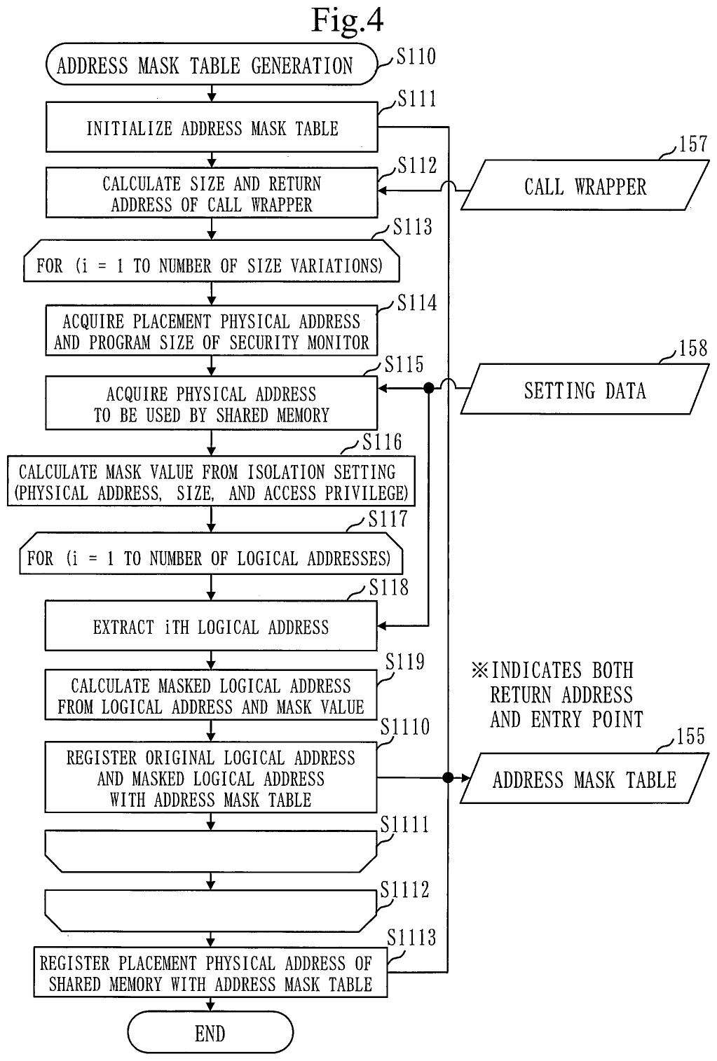

FIG. 4 is a flowchart illustrating operation of the address mask table generation section 120 according to the present embodiment.

The operation of the address mask table generation section 120 (step S110) will be described with referring to FIG. 4.

A purpose of the address mask table generation section 120 is to generate a table for implementing program assignment illustrated in FIG. 2. The address mask table generation section 120 generates the address mask table 155 with a plurality of combinations by varying the physical address and the logical address of the program or the memory used by the program.

The setting data 158 includes size variations of the logical addresses and physical addresses indicated in FIG. 2, and of the shared memory. That is, the setting data 158 has the logical address at which the call wrapper 157 called by the Untrusted program 150 is mapped, the logical address to be assigned to each Trusted program 151, and the physical address of the shared memory; and their size variations.

In step S111, the address mask table generation section 120 initializes the address mask table 155. Specifically, the address mask table generation section 120 empties all rows of the address mask table 155 illustrated in FIG. 2.

In step S112, the address mask table generation section 120 calculates a size and return address of the call wrapper.

The size of the call wrapper is a size of the execution module.

The return address is an address where a return instruction to return to a caller routine is placed in the call wrapper. For example, the return address is an instruction like a jump instruction to jump to an address which is pointed to by a return address register of the processor.

In step S113, the address mask table generation section 120 executes the process repeatedly as many times as the number of size variations of the shared memory size indicated in the setting data 158. This means that the process is repeated from iteration j=1 to j=(the number of size variations).

In step S114, the address mask table generation section 120 acquires a placement physical address and program size of the security monitor 156. The placement physical address and program size are assumed to be values previously stored in the storage device separately of the setting data 158. The security monitor 156 has already been executed before the countermeasure program 152 is executed, and is protected by the memory monitoring section 110. Hence, the physical address and program size to be executed have already been determined, separately of the method of the present embodiment.

In step S115, the address mask table generation section 120 refers to the setting data 158 to acquire the physical address to be used by the shared memory.

In step S116, the address mask table generation section 120 calculates a mask value from the isolation setting.

For example, in RISC-V architecture, a pmpaddr register (address register) expressing a protection-target physical base address and a protection size, and a pmpcfg register (configuration register) which determines an access privilege, determine the isolation setting. The isolation setting is determined as many as the number of protection-target programs. In other words, in general, to determine the isolation setting, information of the physical address, size, and access privilege is required.

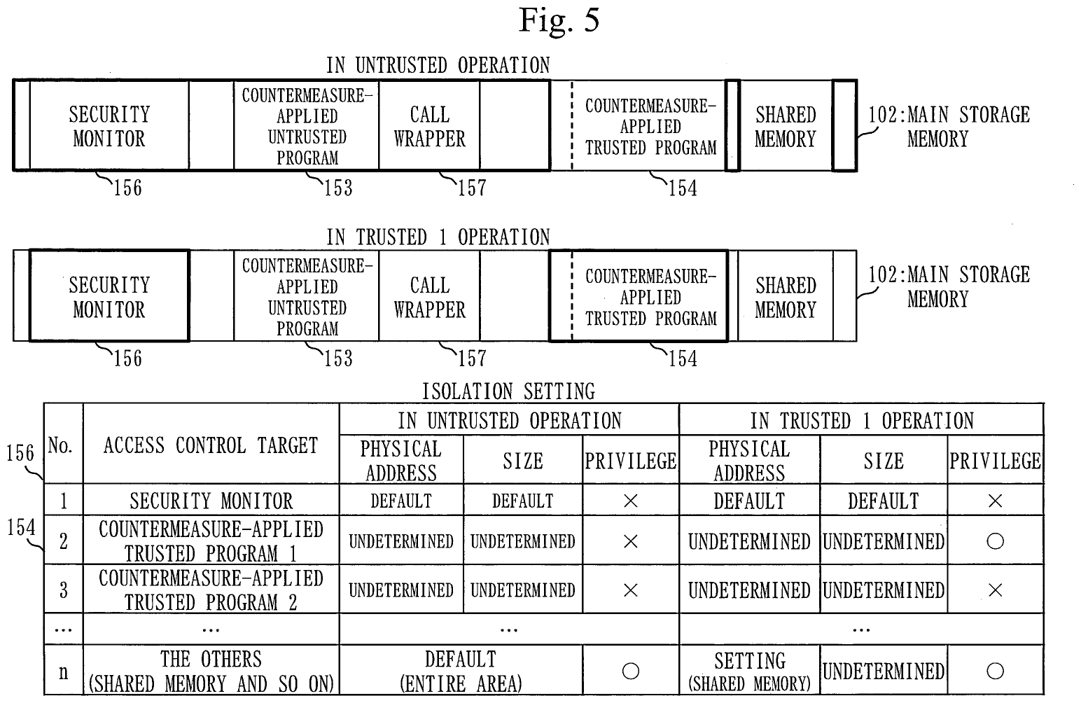

FIG. 5 is a diagram illustrating an example of isolation setting for implementing access control according to the present embodiment.

FIG. 5 illustrates an access control state in operation of the countermeasure-applied Untrusted program 153 and in operation of the countermeasure-applied Trusted program 154. FIG. 5 also illustrates isolation setting to be determined for an access control target, that is, the physical address, size, and access privilege. It is assumed that during Untrusted operation, all areas can be accessed except for programs (the security monitor 156 and the countermeasure-applied Trusted program 154) that should not be accessed. On the other hand, it is assumed that during Trusted operation, the countermeasure-applied Trusted program 154 is prohibited from being accessed except its own memory area and the shared memory. It is assumed that access is not possible if the privilege is not determined explicitly.

The isolation setting for realizing such access control is as illustrated in FIG. 5. The isolation setting includes the physical address, size, and privilege in Untrusted operation and Trusted 1 operation.

Note that “default” of the physical address signifies that a default value exists for the program processing device 100. Specifically, this is a case where “default” refers to the entire area of the security monitor 156 or of the main storage memory 102. Note that “undetermined” of the physical address signifies that the physical address is determined at the time of execution. For example, as for the countermeasure-applied Trusted program 154, its physical memory is allocated at the time of execution, and loaded and mapped. Hence, basically the physical address and size are not determined before execution. Note that “determined” of the physical address signifies that the physical address is defined by the setting data 158. This applies to the physical address of the shared memory.

Privilege “o” signifies having privilege for all of execute, write, and read. Access is possible to all areas in Untrusted operation, an area of the countermeasure-applied Trusted program 154 in Trusted 1 operation, and the shared memory. Privilege “x” signifies not having privilege for any one of execute, write, and read. For example, access to the security monitor 156 is always prohibited.

To sum up the above, every isolation setting of the security monitor 156, the privilege of the countermeasure-applied Trusted program 154, every isolation setting of the others (such as the shared memory) in Untrusted operation, and the privilege of the others (such as the shared memory) are determined before execution of the program. Furthermore, taking the size variation of the setting data into consideration, it is possible to determine the size of the others (such as the shared memory) in Trusted operation.

From the above, assuming an operation as that in FIG. 5, the isolation settings that can be utilized for mask value calculation are every isolation setting of the security monitor 156 and the others (such as the shared memory) and the privilege of the countermeasure-applied Trusted program 154. That is, the physical address and size of the countermeasure-applied Trusted program 154 are not utilized for mask value calculation.

Below, an address register that defines the physical address and size is expressed as RegAddr, and a config register that defines the privilege is expressed as RegCfg. Also, as indicated in FIG. 5, it is also assumed that isolation setting is made according to n pairs of registers (called as entries hereinafter).

Back to step S116, how to calculate a mask value from the isolation setting will be described.

The mask value can be calculated by the next Expression 1.

Mask[j]=Hash(RegAddr[0]|RegCfg[0]|RegCfg[1]∥ . . . ∥RegCfg[n−1]∥RegAddr[n,j]∥RegCfg[n]) Expression (1)

where: Mask [j] is a mask value based on a jth size variation;
Hash ( ) is a hash function;
∥ is coupling of bit strings;
RegAddr [i] (i=1, . . . , n−1) is an ith address register;
RegAddr [n, j] (i=1, . . . , n) is an nth address register based on a jth size variation; and
RegCfig [i] (i=1, . . . , n) is an ith config register.

As indicated in FIG. 5, regarding the shared memory setting in Trusted operation, since the setting of the address register is determined by taking the size variation into consideration, only an nth address register has variations, like RegAddr [n, j].

In step S117, the process is executed repeatedly as many times as the number of logical addresses the setting data has. This means that the process is repeated from iteration i=1 to i=(the number of logical addresses).

In step S118, an ith logical address is extracted by referring to the setting data 158.

In step S119, a masked logical address is calculated from the logical address acquired in step S118 and the mask value calculated in step S116. There are two types of masked logical addresses to be calculated: a mask entry point; and a mask return address, as indicated in FIG. 2. This calculation can be expressed as in Expression (2).

AddrMask[i,j]=(Addr[i]+Offset)(+)Mask[j] Expression (2)

where:
AddrMask [i. j] is a mask jump address (entry point or return address) that is an ith logical address, being masked by a jth mask value;
Offset is an offset value to express an entry point or return address; and
(+) expresses XOR (exclusive OR) operation.

Offset is a size and return address, calculated in step S112, of the call wrapper. When Offset expresses a size of the call wrapper, Offset is an entry point, as indicated in FIG. 2.

When Offset expresses a return address of the call wrapper, Offset is a return address, as indicated in FIG. 2.

Note that since the Untrusted program 150 does not require an entry point, only a mask return address is calculated.

Also, the Untrusted program 150 does not require size variations, as indicated in FIG. 5. Hence, let a size variation of j=1 expresses processing the Untrusted program 150 exceptionally, and only i=1 is handled in step S117, so operation for this purpose can be achieved. Conversely, when j>1, in step S117, if i=1 is ignored, operation for this purpose can be achieved. That is, the address mask table 155 as illustrated in FIG. 2 can be formed.

In step S1110, the original logical address (Addr [i]) and the masked logical address (AddrMask [i, j]) are registered with the address mask table 155. If the logical address acquired in step S117 is an address corresponding to the Trusted program 151, both a mask entry point and a mask return address will be registered.

In step S1111, end check of the iteration of S117 is performed. That is, whether i is not less than the number of logical addresses is determined. If i< (number of logical addresses), the processing proceeds to step S117; if i>=(number of logical addresses), the process proceeds to step S1112.

In step S1112, end check of the iteration of step S113 is performed. That is, whether j is not less than the number of logical addresses is determined. If j< (the number of size variations), the processing proceeds to step S113; if j>=(the number of size variations), the processing proceeds to step S1113.

In step S1113, the physical address of the shared memory acquired in step S115 is registered with the address mask table 155.

Through the above processing, the address mask table 155 as illustrated in FIG. 2 can be generated.

### <Countermeasure Application Process>

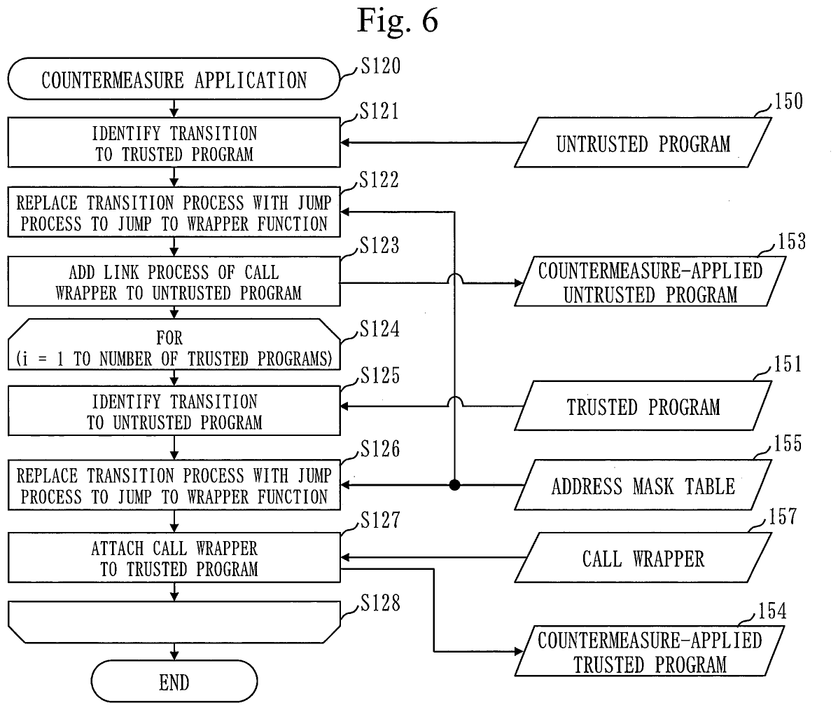

FIG. 6 is a flowchart illustrating operation of the countermeasure application section 130 according to the present embodiment.

The operation of the countermeasure application section 130 (step S120) will be described with referring to FIG. 6.

In step S121, the countermeasure application section 130 analyzes the Untrusted program 150 to identify transition to the Trusted program 151.

Specifically, the transition is an environment call exception instruction. For example, in the case of RISC-V architecture, to perform switch between Trusted and Untrusted, generally, a program with higher privilege (the security monitor 156) is called using environment call exception. That is, an execution location of an environment call exception instruction ECALL is identified. Step S121 is, for example, a process performed by the transition identification section 111 of the countermeasure application section 130.

In step S122, the countermeasure application section 130 looks up the address mask table 155 to replace the transition process with a jump instruction to jump to a wrapper function. The jump address of the transition destination is a logical address of the address mask table 155 in both of the case of the Untrusted program 150 and the case of the Trusted program 151, as indicated in FIG. 2. That is, this address expresses the address of the call wrapper (entry point to a function). Step S122 is, for example, a process performed by the transition process replacement section 112 of the countermeasure application section 130.

In step S123, the countermeasure application section 130 adds a link process of the call wrapper 157 to the Untrusted program 150, instead of statically attaching the call wrapper 157 before executing the program. This completes generation of the countermeasure-applied Untrusted program 153. Step S123 is, for example, a process performed by the countermeasure-time linking section 113 of the countermeasure application section 130.

The reason the call wrapper is not attached at this point is as follows. If the call wrapper 157 is attached to the beginning of the Untrusted program 150, when an entry point is executed, the call wrapper 157 operates, so the original process is not executed. If the call wrapper 157 is attached to the end of the Untrusted program 150, the entry point changes depending on the program size, and the logical address of the address mask table 155 changes from program to program. That is, it is necessary to make a link at the time of execution to guarantee the process completeness while generating a universal address mask table 155.

The countermeasure application section 130 statically attaches a call wrapper to the Trusted program, but does not attach a call wrapper to the Untrusted program for the reason described above.

In step S124, the countermeasure application section 130 executes the process repeatedly as many times as the number of Trusted programs 151. This means that the process is repeated from iteration i=1 to i=(the number of Trusted programs 151).

In step S125, the countermeasure application section 130 analyzes a Trusted program 151 corresponding to iteration i, to identify transition to an Untrusted program.

This process is the same as that in step S121.

In step S126, the countermeasure application section 130 looks up the address mask table 155 to replace the transition process with a jump instruction to jump to a wrapper function. This process is the same as that in step S122.

In step S127, the countermeasure application section 130 attaches a call wrapper to the beginning of the Trusted program 151. This means coupling the Trusted program 151 and the call wrapper to form a bit string. In this manner, the countermeasure application section 130 completes generation of the ith countermeasure-applied Trusted program 154.

At this time, the countermeasure application section 130 may perform alignment by 0-padding according to the size of the call wrapper to match the bit width of the processor. In this case, in step S112, the countermeasure application section 130 calculates the size of the call wrapper taking into consideration 0-padding as well.

In step S128, end check of the iteration of step S124 is performed. That is, whether i is not less than the number of Trusted programs is determined. If i< (the number of Trusted programs), the processing returns to step S124; if i>=(the number of Trusted programs), the processing ends.

### <Execution Process>

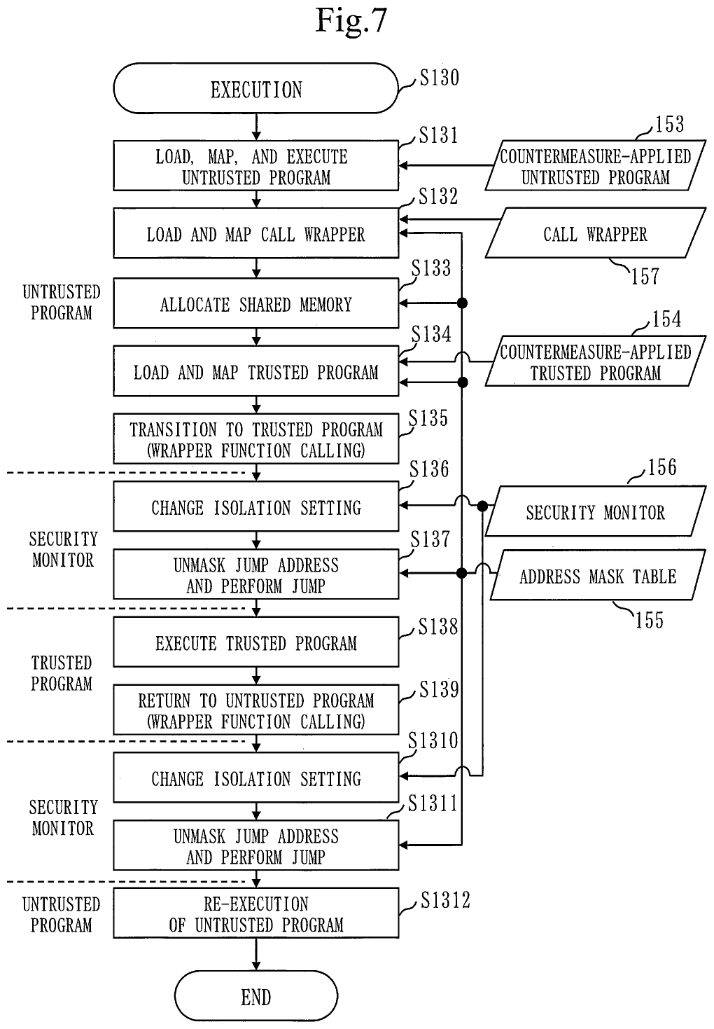

FIG. 7 is a flowchart illustrating operation of the execution section 140 according to the present embodiment.

The operation of the execution section 140 (step S130) will be described with referring to FIG. 7.

The execution section 140 is executed by the countermeasure-applied Untrusted program 153, the security monitor 156, and the countermeasure-applied Trusted program 154 as they take control in turn.

### Countermeasure-Applied Untrusted Program 153

In step S131, the execution section 140 loads and map the countermeasure-applied Untrusted program 153 to the main storage memory 102 and executes the countermeasure-applied Untrusted program 153. Specifically, the execution section 140 allocates a physical memory, assigns a logical address to the physical memory, and sets a program counter at an entry point. This is an ordinary operation that takes place when the OS executes a binary program.

In step S132, the execution section 140, when executing the program, executes the dynamic link process added in step S123, thereby linking the call wrapper 157. That is, the execution section 140 loads and maps the call wrapper 157 by the operation of the dynamic link process which is attached by the countermeasure application section 130 in step S123. The execution section 140 allocates a physical address and assigns a logical address to the physical address. At this time, the logical address to be assigned is determined by looking up the address mask table 155. Specifically, a logical address of ID=0 is employed, as illustrated in FIG. 2.

This process is the dynamic link process which is attached in step S123 by the countermeasure application section 130.

In step S133, the execution section 140 allocates a shared memory. At this time, the memory allocation section 141 functions instead of a process of the OS to use an empty physical memory, and assigns a physical memory by looking up the address mask table 155. Specifically, a physical address of ID=−1 is selected. It is also possible to utilize a logical address that is assigned automatically.

In step S134, the execution section 140 loads and maps the countermeasure-applied Trusted program 154. At this time, instead of a process of the OS to load and map the countermeasure-applied Trusted program 154 by using an empty memory, the loading section 142 functions, and acquires from the address mask table 155 a logical address to be assigned to an empty physical memory. Specifically, the number of pieces of countermeasure-applied Trusted programs 154 which are to be loaded and mapped corresponds to the ID. For example, for a first program, ID=1; for an nth program, ID=n.

In step S135, the execution section 140 transitions to the countermeasure-applied Trusted program 154 which is mapped in step S134. This process is the process replaced in step S122, and the call wrapper 157 is called. That is, the security monitor 156 is called as an intermediary for transition to the countermeasure-applied Trusted program 154.

### Security Monitor 156

In step S136, the execution section 140 changes the isolation setting with the security monitor 156. That is, as illustrated in FIG. 5, the execution section 140 performs the setting according to the access privilege for Untrusted operation and Trusted operation.

In step S137, the execution section 140 refers to the jump address from the address mask table 155, unmasks the jump address, and performs a jump. At this time, usually the execution section 140 transitions to the entry point of the countermeasure-applied Trusted program 154 according to the address table managed by the security monitor 156. Instead, however, the transition is replaced with this process by the feature of the jump address unmasking section 143.

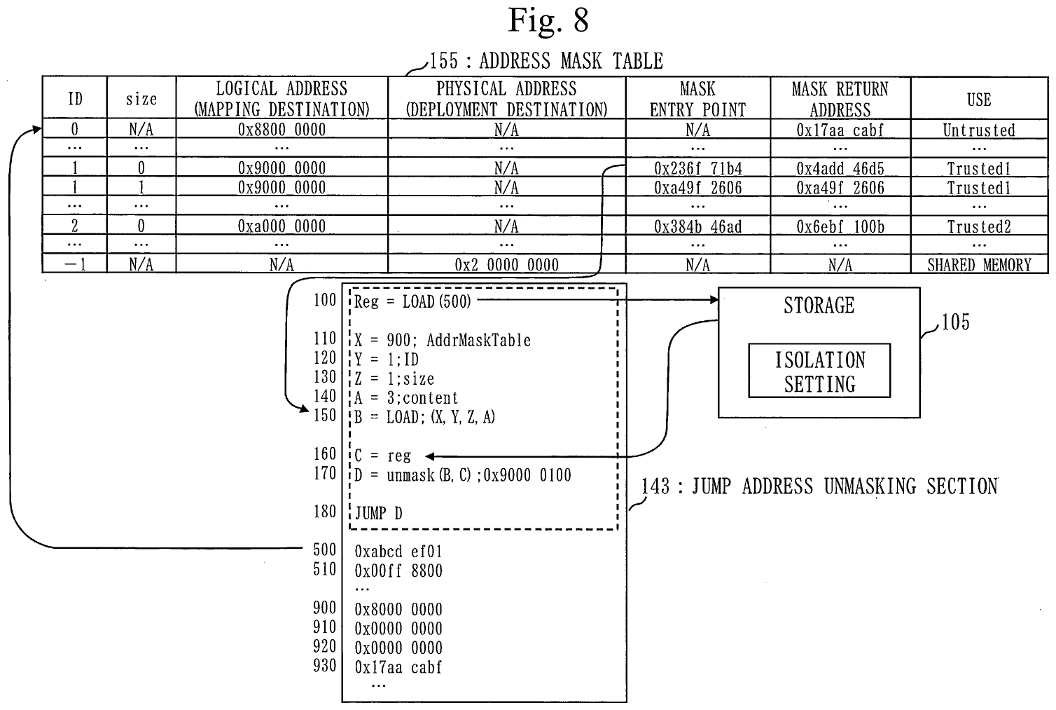

FIG. 8 is a diagram illustrating a sequence from change of isolation setting to execution of a jump address unmasking process according to the present embodiment.

The sequence from the change of isolation setting in step S136 to the jump address unmasking process of unmasking the jump address and performing a jump in step S137 will be described with referring to FIG. 8.

FIG. 8 illustrates how the feature of the jump address unmasking section 143 is executed according to the address mask table 155.

In line 100, the jump address unmasking section 143 refers to line 500 to acquire data, and assigns the data to a register reg that manages the isolation setting of the storage 105. Thus, the isolation setting is changed.

In lines 110 to 150, the jump address unmasking section 143 acquires the masked entry point of the countermeasure-applied Trusted program 154 from the address mask table 155. For this purpose, data is loaded by specifying the base address, ID, size, and contents to be acquired (entry point, return address, and so on).

The jump address unmasking section 143 performs an unmasking process in lines 160 and 170. That is, the jump address unmasking section 143 unmasks the masked address loaded in line 150 by using the isolation setting recorded in the storage 105. This process is an inverse process of Expressions (1) and (2), and can be expressed as the following Expression (3).

Addr=AddrMask(+)Hash(RegAddr[0]∥RegCfg[0]∥RegCfg[1]∥ . . . ∥RegCfg[n−1]∥RegAddr[n]∥RegCfg[n]) Expression (3)

The value of a logical address obtained in this manner is, for example, a value such as “0x9000 0100” shown in line 170 of FIG. 8. That is, as will be described later, this signifies that the call wrapper uses “0x9000 0000 to 0x9000 0100” and that the entry point starts at “0x9000 0100”.

In line 180, a jump is made to the address obtained by unmasking.

With the above operations, it is possible to perform a sequence from change of the isolation setting, unmasking the masked jump address, and transition to appropriate processing.

### Countermeasure-Applied Trusted Program 154

Back to FIG. 7, in step S138, the execution section 140 executes the process of the countermeasure-applied Trusted program 154.

In step S139, the execution section 140 returns to the countermeasure-applied Untrusted program 153. This process is the process replaced in step S126, and the call wrapper 157 is called. That is, the security monitor 156 is called as an intermediary for returning to the countermeasure-applied Untrusted program 153.

### Security Monitor 156

In step S1310, the execution section 140 changes the isolation setting. This process is the same as that of step S136. Note that the isolation setting is the setting for Untrusted.

In step S1311, the execution section 140 refers to the jump address from the address mask table 155, unmasks the jump address, and performs a jump. This process is the same as that of step S137. Note that the address to be referred to from the address mask table 155 is the unmasked return address of the Untrusted program.

### Countermeasure-Applied Untrusted Program 153

In step S1312, the execution section 140 returns to the process of the countermeasure-applied Untrusted program 153, and executes the remaining process.

The above is the operation of the program processing device 100. However, in FIG. 7, the original process of each program is omitted, and only the processes related to context switching are picked out and explained.

### Description of Characteristic

In the program processing device 100 according to the present embodiment, the isolation settings used for the calculation of the mask value are selectively limited to significant ones, as described with reference to FIG. 5. That is, a combinatorial explosion that occurs when every possibility is taken into consideration is prevented, so that an address mask table 155 of a realistic size can be generated.

The choice of the isolation setting here also leads to no limitation of program size. Specifically, the physical addresses used by the countermeasure-applied Trusted program 154 are not used for the calculation of the mask value. This prevents the program size from having to be defined in advance.

The use of the call wrapper 157 leads to uniquely limiting the return address in the context switch between Untrusted and Trusted. That is, this limitation has an effect of not only fixing the return address to realize masking of the jump address, but also reducing the table size of the address mask table 155.

Providing size variations to the setting data 158 prevents limiting the shared memory size. This has the same meaning as not defining the program size of the countermeasure-applied Trusted program 154. However, the address register resulting from the size of the physical address of the shared memory must be employed in the calculation of the mask value. This is because, as illustrated in FIG. 5, in the context switch between Untrusted and Trusted where the setting of an address register (physical address and size) of No. n changes, if this value is not included in the mask calculation, it will be impossible to notice that this value has been destroyed.

Variations of address mask table 155 are not limited to the format illustrated in FIG. 2.

For example, the address mask table 155 may be created with variations that limit the physical addresses and sizes of one or more countermeasure-applied Trusted programs. In that case, the number of size columns in address mask table 155 increases, and the number of combinations increases by multiplication. Then, when the execution section 140 operates, the feature of the memory allocation section 141 must be utilized in addition to the feature of the loading section 142.

Alternatively, the physical addresses used by the shared memory may be fixed, not taking their variations into consideration.

Since the address mask table 155 is generated taking into consideration the variations of the shared memory size, the address mask table 155 is not limited to use with the countermeasure-applied Untrusted program 153 and the countermeasure-applied Trusted program 154 which are generated by processing with the countermeasure program 152. That is, even if the countermeasure program 152 is operated by providing another Untrusted program 150 and another Trusted program 151, if the setting data 158 is the same, the same address mask table 155 is generated.

The countermeasure program 152 has been described as sequentially executing the address mask table generation (step S110), countermeasure application (step S120), and execution (step S130). It may be possible to operate only one of them.

For example, in the second and following executions, only the execution section 140 may be carried out. That is, it is possible to execute the program by operating the existing call wrapper 157 and security monitor 156 with using the generated countermeasure-applied Untrusted program 153, the countermeasure-applied Trusted program 154, and the address mask table 155.

Alternatively, under an assumption that the setting data 158 does not change, program execution may start with countermeasure application to a new Untrusted program 150 and a new Trusted program 151.

The address mask table 155 may be implemented as a hash table. That is, as illustrated in FIG. 8, values that can be originally referred to when specifying the ID, size, and content may be stored at an address indicated by values obtained by specifying and hashing the ID, size, and content. This makes it possible to prevent an unintended value (for example, a raw logical address value) from being exposed when a fault attack is made in a process of looking up the address mask table 155.

An address mask table 155 generated by the address mask table generation section 120 according to this method is a larger, sparser table. When looking up the address mask table 155, a change is made to look up the address mask table 155 by using hashed values of the ID, size, and content, as a key. An example of hashing is shown in the following Expression (4).

Hash(ID∥size∥content) Expression (4)

### Description of Effect

The program processing device 100 according to the present embodiment calculates a mask value based on the logical address and physical address specified by the setting data and based on the isolation setting for each program. Then, the program processing device 100 generates an address mask table where a masked jump address is written together with the original logical address and physical address. Furthermore, the program processing device 100 replaces the transition process of the context switch process (a process in which Untrusted and Trusted change) of the execution-target program with call wrapper calling. Also, the program processing device 100, at the time of execution, looks up the address mask table to allocate a physical address or to assign a logical address. In context switch, the program processing device 100 unmasks the masked jump address extracted from the address mask table with using the isolation setting, and then performs transition.

With the above-described operation, the program processing device 100 according to the present embodiment makes it possible to apply a jump address masking scheme by partially fixing logical addresses or physical addresses and executing a program even in an OS environment.

In the program processing device 100 according to the present embodiment, the address mask table generation section 120 generates an address mask table which records a list of: a mask value of the entry point and a mask value of a return address; and the logical addresses and physical addresses used by the program or shared memory, based on the setting data. The setting data records: the access privilege settings (isolation settings) of the TEE; the logical addresses, physical addresses, and shared memory used by the program (application); and size variations of the program size.

Furthermore, the countermeasure application section attaches to the Untrusted and Trusted programs a call wrapper as proxy that processes context switch based on the address mask table before the programs are executed.

Furthermore, the execution section dynamically attaches the call wrapper at execution time with using the address mask table, and executes the countermeasure-applied Untrusted program Trusted program, and the security monitor.

The memory monitoring section monitors memory access based on the determined isolation setting.

According to the program processing device 100 of the present embodiment, even in a TEE as an OS environment, a jump address can be masked and unmasked by partially fixing the physical address where the program or the shared memory is placed, or the assigned logical address, and executing the program. If context switch occurs with the isolation setting being destroyed, a correct jump address cannot be calculated in the unmasking process, resulting in a jump to an unusual address. Such an action can be monitored by the memory monitoring section 110 to prevent unauthorized memory accesses. That is, it is possible to ensure that correct isolation settings are in place when the program is in execution.

### Embodiment 2

In the present embodiment, differences from Embodiment 1 and additions to Embodiment 1 will be mainly described.

In the present embodiment, a configuration having the same feature as its counterpart in Embodiment 1 will be denoted by the same reference numeral, and its description will be omitted.

### Description of Configuration

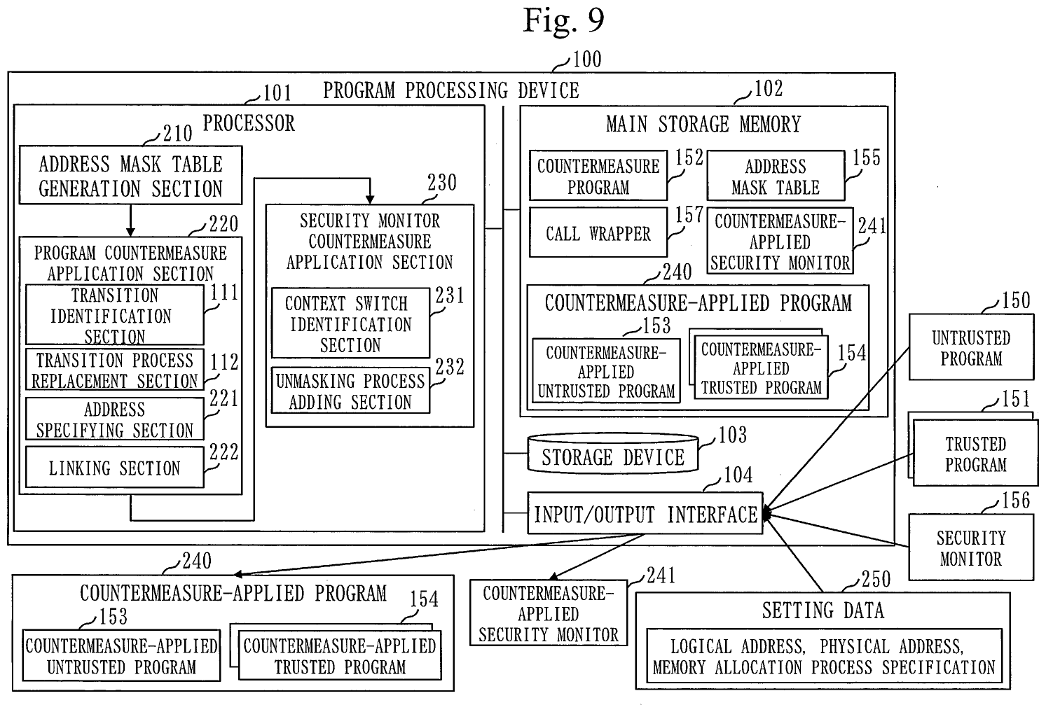

FIG. 9 is a diagram illustrating a configuration example of a program processing device 100 according to the present embodiment.

Differences from the configuration of the program processing device 100 illustrated in FIG. 1 will particularly be described.

A processor 101 is provided with elements such as an address mask table generation section 210, a program countermeasure application section 220, and a security monitor countermeasure application section 230. The program countermeasure application section 220 includes a transition identification section 111, a transition process replacement section 112, an address specifying section 221, and a linking section 222. The security monitor countermeasure application section 230 includes a context switch identification section 231 and an unmasking process adding section 232.

The address mask table generation section 210, the program countermeasure application section 220, and the security monitor countermeasure application section 230 are implemented by software.

A countermeasure program 152 operated by the processor 101 and a call wrapper 157 to be used by the countermeasure program 152 are stored in a storage device 103.

As illustrated in FIG. 9, software and data stored in the storage device 103 are loaded to a main storage memory 102. An address mask table 155, a countermeasure-applied program 240, and a countermeasure-applied security monitor 241 which are generated by the countermeasure program 152 are stored in the main storage memory 102.

An Untrusted program 150, a Trusted program 151, a security monitor 156, and setting data 250 are inputted via an input/output interface 104. Furthermore, when the countermeasure program 152 operates execution, the countermeasure-applied program 240 and the countermeasure-applied security monitor 241 are outputted.

The setting data 250 includes a logical address, a physical address, and memory allocation process specification. The logical address and the physical address are the same as those of the setting data 158 in Embodiment 1. However, as the physical address, the setting data 250 includes the physical address of the security monitor 156.

The setting data 250 does not have size variations like the setting data 158 of Embodiment 1, and calculates addresses which are masked such that they are suitable for the inputted Untrusted program 150 and Trusted program 151. For this purpose, the setting data 250 has memory allocation process specification. That is, the setting data 250 specifies a shared memory allocated by the protection-target Untrusted program 150 or a load-and-map process portion of the Trusted program 151 so that the Untrusted program 150 and the Trusted program 151 can be analyzed, and replaces the process so that jump address masking can be applied.

The Untrusted program 150, the Trusted program 151, and the security monitor 156 of the present embodiment are source codes.

The countermeasure-applied program 240 and the countermeasure-applied security monitor 241 are execution modules which are executable.

That is, in short, the program processing device 100 is a compiling device. It is assumed that a compiled program is operated on a processor having a memory monitoring section 110.

### Description of Operation

Next, operation of the program processing device 100 according to the present embodiment will be described. An operation procedure of the program processing device 100 corresponds to a program processing method. Also, a program that implements the operation of the program processing device 100 corresponds to a program processing program.

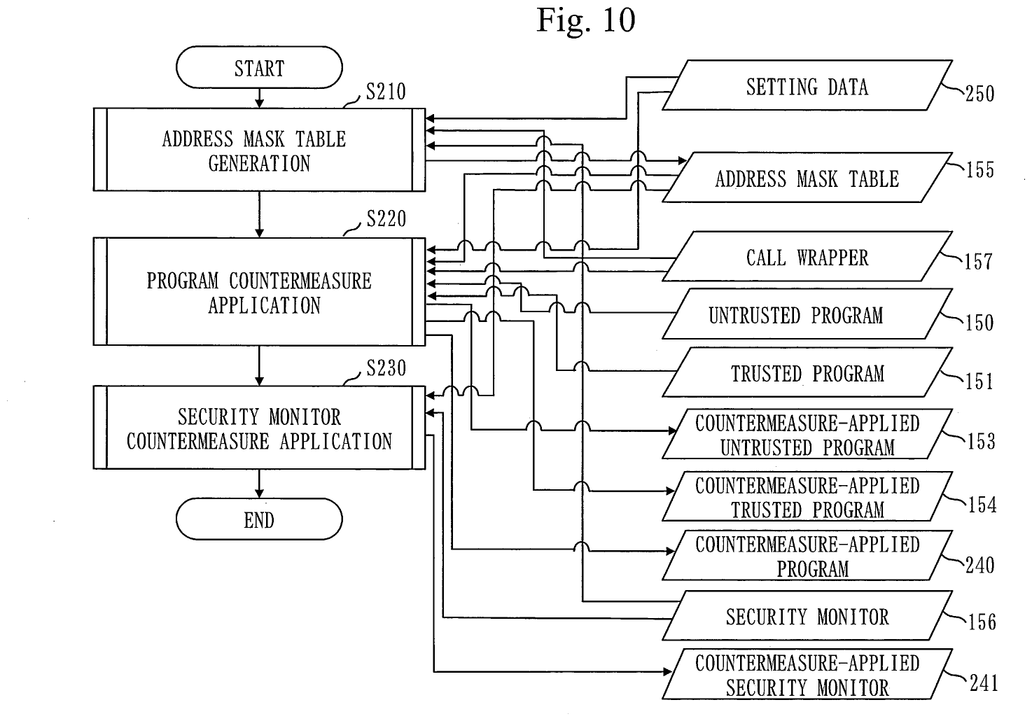

FIG. 10 is a flowchart illustrating the operation of the program processing device 100 according to the present embodiment.

The operation of the program processing device 100 will be described with referring to FIG. 10.

In step S210, the countermeasure program 152 executes the feature of the address mask table generation section 210 to generate an address mask table. In generating the address mask table, the setting data 250, the call wrapper 157, and the security monitor 156 are inputted to generate the address mask table 155.

In step S220, the countermeasure program 152 executes the feature of the program countermeasure application section 220 to apply countermeasures to the program. The program countermeasure application section 220 attaches to the program the call wrapper 157 being a function to performs context switch, and identifies a transition process of performing the context switch from the program. Then, the program countermeasure application section 220 replaces the transition process with a process of performing a jump by specifying a physical address where the call wrapper 157 is to be deployed, allocates a memory by specifying a logical address and a physical address according to the address mask table 155, and assigns the logical address.

At this time, the setting data 250, the call wrapper 157, the security monitor 156, the Untrusted program 150, and the Trusted program 151 are inputted, and the countermeasure-applied program 240 (a countermeasure-applied Untrusted program 153 and a countermeasure-applied Trusted program 154) is generated.

Specifically, the linking section 222 attaches the call wrapper 157 to the program. The transition identification section 111 identifies a process that performs context switch from the program. The transition process replacement section 112 replaces the identified transition process with a process of performing a jump by specifying an address where the call wrapper 157 is to be deployed. The address specifying section 221 allocates a memory by specifying a logical address and a physical address according to an address mask table 155, and assigns the logical address.

In step S230, the countermeasure program 152 executes the feature of the security monitor countermeasure application section 230 and applies a countermeasure to the security monitor 156. The security monitor countermeasure application section 230 identifies context switch of the security monitor 156. Then, the security monitor countermeasure application section 230 changes a jump address acquisition process existing before the identified context switch to the following process. That is, the security monitor countermeasure application section 230 changes the jump address acquisition process to “a process of: acquiring a jump address which is masked, as a mask jump address by looking up the address mask table 155; performing an unmasking process on the acquired mask jump address based on the determined isolation setting; and calculating a jump address”. At this time, the address mask table 155 and the security monitor 156 are inputted, and the countermeasure-applied security monitor 241 is outputted.

Specifically, the context switch identification section 231 identifies context switch of the security monitor 156. Then, the unmasking process adding section 232 changes the jump address acquisition process existing before the identified context switch as follows. That is, the unmasking process adding section 232 changes the above-mentioned jump address acquisition process to “a process of: acquiring the masked jump address from the address mask table 155; performing an unmasking process based on the isolation setting of the time the jump process is executed; and calculating the jump address”.

This will be described using a more specific case. For example, assume a jump to an entry point of program1.
A normal process is as follows.
Normal:
RegJump<-Mem (entry_program1):
JUMP RegJump;

With the program processing device 100 according to the present embodiment, the process is as follows.
Addition of Unmasking Process:
RegTemporary<-Mem (address_mask_table+offset);
RegTemporary<-RegTemporary xor pmpaddr; RegTemporary<-RegTemporary xor pmpcfg;
RegJump<-RegTemporary;
JUMP RegJump;

Here, offset signifies a position number on jump address table, that is, has a meaning like ID in FIG. 8. It is assumed that the mask address that masked entry_program1 is stored at this offset. Therefore, when creating a mask address table, that is, in masking, “entry_program1 xor pmpaddr xor pmpcfg” is placed at the address of “address_mask_table+offset”.

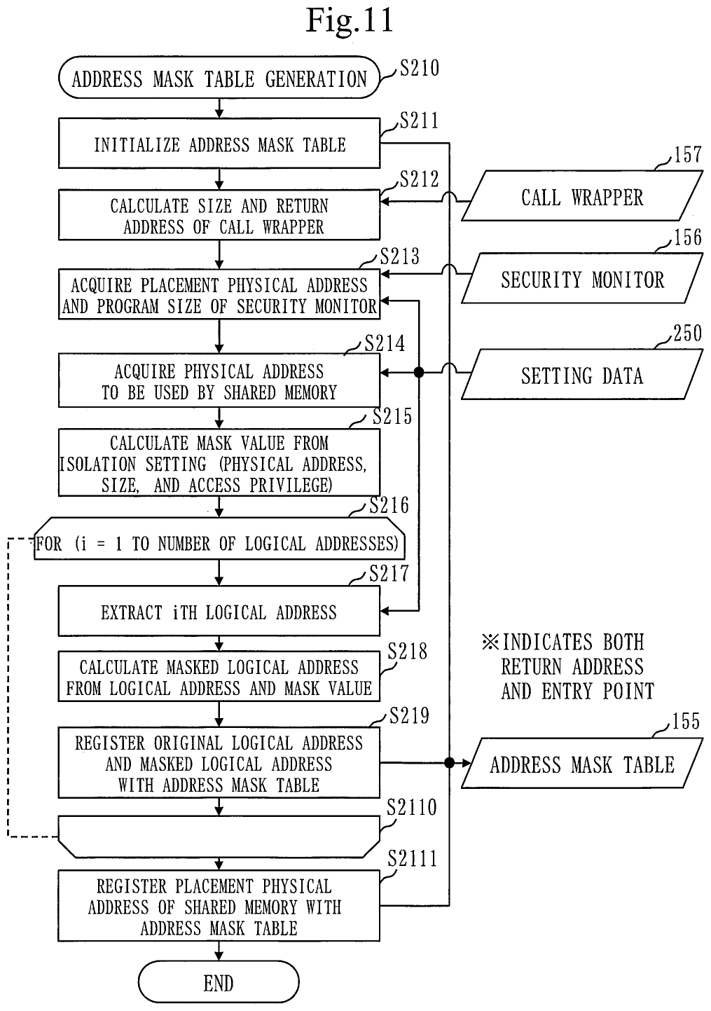

FIG. 11 is a flowchart illustrating operation of the address mask table generation section 210 according to the present embodiment.

Address mask table generation (step S210) will be described with referring to FIG. 11.

Step S211, step S212, and step S214 to step S2111 are the same as step S111, step S112, step S115 to step S1111, and step S1113.

Steps that differ will be described below.

In step S213, the address mask table generation section 210 acquires a placement physical address of the security monitor 156 by referring to the setting data 250, and acquires the program size from the security monitor 156. In step S215, these pieces of information are used to calculate a mask value from the isolation setting, as in Embodiment 1.

In order to acquire the program size, the source code may be compiled once. Alternatively, a memory size to be used for the security monitor 156 may be provided as setting data 250.

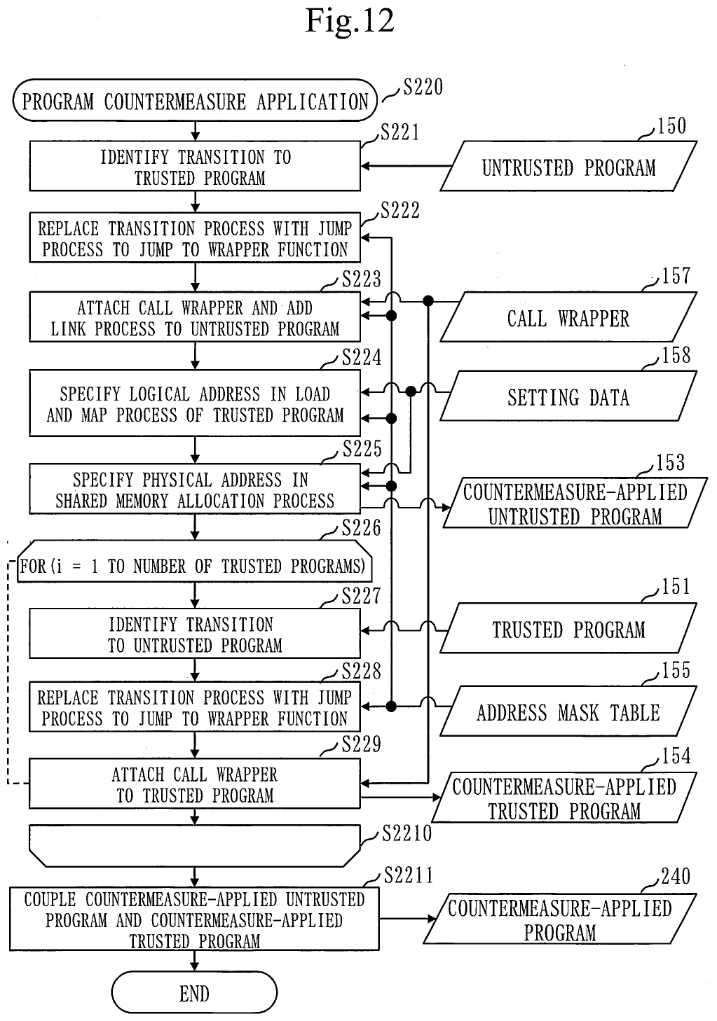

FIG. 12 is a flowchart illustrating operation of the program countermeasure application section 220 according to the present embodiment.

Program countermeasure application (step S220) will be described with referring to FIG. 12.

Step S221, step S222, and step S226 to step S2210 are the same as step S121, step S122, and step S124 to step S128.

Steps that differ will be described below.

In step S223, the program countermeasure application section 220 attaches the call wrapper 157 to the Untrusted program 150, and adds a link process by looking up the address mask table 155.

As described above, since the Untrusted program 150 is executed after the OS to be executed first is deployed, if a call wrapper is attached to the beginning or end of the Untrusted program 150, the Untrusted program 150 will not be executed properly. Therefore, the call wrapper 157 is attached to the Untrusted program 150 once, and then after execution, the call wrapper 157 is rearranged.

First, the call wrapper 157 is added to the Untrusted program 150. Next, a process of copying the call wrapper 157 to an address indicated on the address mask table 155 is added to the Untrusted program 150.

In step S222, the transition process is rewritten so as to call a function that is assumed to be stored in the above-mentioned copy destination address. Thus, the call wrapper 157 is called successfully.

In step S224, first, the program countermeasure application section 220 refers to the memory allocation process specification indicated in the setting data 158 to identify the load and map process of the Trusted program 151. Next, the program countermeasure application section 220 specifies the logical address indicated in the address mask table 155, as a destination logical address to be mapped at this time.

In step S225, first, the program countermeasure application section 220 identifies a shared memory allocation process by referring to the memory allocation process specification indicated in setting data 158. Next, the program countermeasure application section 220 specifies a physical address indicated in the address mask table 155, as the physical address to be allocated at this time.

In step S2211, the countermeasure-applied Untrusted program 153 and the countermeasure-applied Trusted program 154 which are generated so far are coupled to generate the countermeasure-applied program 240.

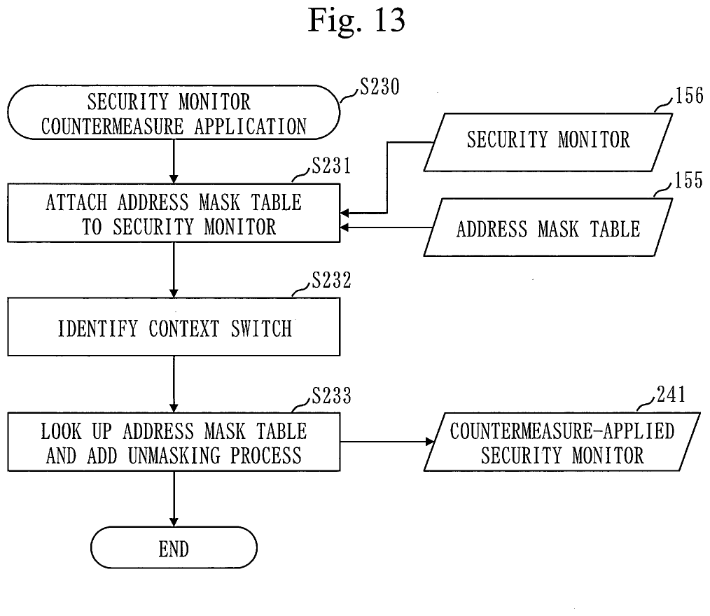

Security monitor countermeasure application (step S230) will be described with referring to FIG. 13.

In step S231, the address mask table 155 is attached to the security monitor 156. For example, the address mask table 155 expressed in a two-dimensional array is added, with no change, to the source code of the security monitor 156.

In step S232, the location of the context switch is identified. For example, in RISC-V architecture, the security monitor 156 called by an environment call exception instruction (ECALL) transitions to a switched context destination by executing an exception return instruction (MRET). That is, the location of the context switch can be identified by identifying the execution location of such an instruction.

In step S233, an unmasking process is added by looking up the address mask table 155. A location where a transition destination address is to be set exists before the context switch identified in step S232. This adding process is replaced as follows.

Before change: A jump address (entry point or return address) is acquired from a particular location and set as the transition destination.

After change: A jump address is acquired from the address mask table 155; an unmasking process is performed to calculate the jump address; and the unmasked jump address is set as the transition destination.

Unmasking is performed by the same method as that in Embodiment 1.

### Description of Effect

According to the program processing device 100 of the present embodiment, it is possible to generate a countermeasure-applied program 240 and a countermeasure-applied security monitor 241 that are assumed to be used for TEE in an OS environment. That is, by partially fixing and executing the physical addresses where the program or shared memory is to be placed and the logical addresses which are to be assigned, it is possible to mask and unmask the jump addresses. If context switch occurs in a state where the isolation setting is destroyed, a correct jump address cannot be calculated in the unmasking process, and a jump to an abnormal address occurs.

Such an operation is monitored by the memory monitoring section 110, so an unauthorized memory access can be prevented. In other words, it is possible to guarantee that when the program is operating, the isolation setting is correct.

In the above Embodiments 1 and 2, each section of the program processing device has been described as an independent function block. However, the configuration of the program processing device need not be like the one in the above-described embodiments. The function block of the program processing device may have any configuration as long as it can realize the features described in the above embodiments. Furthermore, the program processing device need not be a single device, but may be a system composed of a plurality devices.

Furthermore, it is possible to combine a plurality of portions of Embodiments 1 and 2 and to practice them. Also, it is possible to practice only one portion of these embodiments. In addition, it is possible to practice of these embodiments in, either as a whole or partially.

That is, in Embodiments 1 and 2, it is possible to combine the embodiments freely, or to modify an arbitrary constituent element of each embodiment, or to omit an arbitrary constituent element in each embodiment.

The above-described embodiments are essentially preferred exemplifications, and are not intended to limit the scope of the present disclosure, the scope of applied products of the present disclosure, and the scope of use of the present disclosure. The above-described embodiments can be modified in various manners as necessary. For example, the procedures described with flowcharts or sequence diagrams may be modified as appropriate.

### REFERENCE SIGNS LIST

100: program processing device; 101: processor; 102: main storage memory; 103: storage device; 104: input/output interface; 105: storage; 110: memory monitoring section; 120: address mask table generation section; 130: countermeasure application section; 111: transition identification section; 112: transition process replacement section; 113: countermeasure-time linking section; 140: execution section; 141: memory allocation section; 142: loading section; 143: jump address unmasking section; 144: execution-time linking section; 150: Untrusted program; 151: Trusted program; 152: countermeasure program; 153: countermeasure-applied Untrusted program; 154: countermeasure-applied Trusted program; 155: address mask table; 156: security monitor; 157: call wrapper; 158: setting data; 210: address mask table generation section; 220: program countermeasure application section; 221: address specifying section; 222: linking section; 230: security monitor countermeasure application section; 231: context switch identification section; 232: unmasking process adding section; 240: countermeasure-applied program; 241: countermeasure-applied security monitor; 250: setting data.

1. A program processing device comprising
processing circuitry
to generate an address mask table about a program or a memory used by the program based on setting data which specifies a physical address and a logical address,
to attach to the program a call wrapper being a function that performs context switch; to identify a transition process of performing the context switch from the program; and to replace the transition process with a process of performing a jump by specifying a physical address where the call wrapper is to be deployed, and
to look up the address mask table, in executing a countermeasure-applied program, so as to allocate a memory and to assign a physical address; and instead of acquiring a jump address with no change in the transition process, to make a change so as to use a jump address obtained by unmasking the jump address acquired by looking up the address mask table, based on determined isolation setting.

2. The program processing device according to claim 1,
wherein the processing circuitry generates the address mask table with a plurality of combinations by the program by varying the physical address and the logical address about the program or the memory used by the program.

3. The program processing device according to claim 1,
wherein the processing circuitry
adds a link process of the call wrapper instead of statically attaching the call wrapper before executing the program, and
when executing the program, executes the link process which is dynamic, thereby linking the call wrapper.

4. The program processing device according to claim 2,
wherein the processing circuitry
adds a link process of the call wrapper instead of statically attaching the call wrapper before executing the program, and
when executing the program, executes the link process which is dynamic, thereby linking the call wrapper.

5. The program processing device according to claim 1,
wherein the processing circuitry generates the address mask table as a hash table.

6. The program processing device according to claim 2,
wherein the processing circuitry generates the address mask table as a hash table.

7. The program processing device according to claim 3,
wherein the processing circuitry generates the address mask table as a hash table.

8. The program processing device according to claim 4,
wherein the processing circuitry generates the address mask table as a hash table.

9. A program processing device comprising
processing circuitry
to generate an address mask table about a program or a memory used by the program based on setting data which specifies a physical address and a logical address,
to attach to the program a call wrapper being a function that performs context switch; to identify a transition process of performing the context switch from the program; to replace the transition process with a process of performing a jump by specifying a physical address where the call wrapper is to be deployed; to allocate a memory by specifying a logical address and a physical address according to the address mask table; and to assign the logical address, and
to identify context switch of a security monitor, and to change a jump address acquisition process existing before the identified context switch, to a process of: acquiring a jump address which is masked, as a mask jump address by looking up the address mask table; performing an unmasking process on the acquired mask jump address based on determined isolation setting; and calculating a jump address.

10. A program processing method comprising:
generating an address mask table about a program or a memory used by the program based on setting data which specifies a physical address and a logical address;
attaching to the program a call wrapper being a function that performs context switch; identifying a transition process of performing the context switch from the program; and replacing the transition process with a process of performing a jump by specifying a physical address where the call wrapper is to be deployed; and
looking up the address mask table, in executing a countermeasure-applied program, so as to allocate a memory and to assign a physical address; and instead of acquiring a jump address with no change in the transition process, making a change so as to use a jump address obtained by unmasking the jump address acquired by looking up the address mask table, based on determined isolation setting.
